(19) United States
(12) Patent Application Publication
(10) Pub. No.: US 2011/0112677 A1
(43) Pub. Date: May 12, 2011

(54) METHOD FOR CONTROLLING A PHYSICAL PROPERTY OF A TUBULAR BLOWN FILM

(76) Inventor: Albert John Franklin, (US)

(21) Appl. No.: 12/616,515

(22) Filed: Nov. 11, 2009

(51) Int. Cl. G06F 17/50

(52) U.S. Cl. 700/103

(57) ABSTRACT

A method for controlling a physical property of a collapsed blown film extruded form a ring-shaped extruder having a plurality of physical property controllers disposed around the extruder includes the following steps. First, an even number of longitudinal sections of the blown film are identified. Next, the physical property profile is measured a first time across the entire width of the collapsed film. Because the longitudinal sections at the ends of the collapsed film overlap themselves, the physical property of these two longitudinal sections is determined by dividing the measured value by two. The film is then rotated, and the physical property profile is measured a second time. Again, the physical property of the longitudinal sections at the ends of the rotated film are determined by dividing their measured value by two. Then the physical properties of the remaining longitudinal sections are determined by subtracting the physical property value of a longitudinal section which has been previously determined from a measured value from either the first or second physical property profile.

### FIELD OF THE INVENTION

This invention relates generally to tubular blown films and, more particularly, to methods for controlling the thickness profile of tubular blown films.

### BACKGROUND OF THE INVENTION

Tubular blown films have become very popular methods of producing inexpensive plastic bags and plastic sheets made from single or multiple layer plastic polymer materials, such as polyethylene, polypropylene, polyamide, ethylene vinyl acetate, ethylene vinyl alcohol and ionomers.

Typically, a tubular blown film is produced by extruding the plastic film from a ring-shaped extruder. In some cases, the blown film may contain multiple layers of different polymers co-extruded into one multi-layer film, having a total thickness and discernable internal layer thicknesses. Because blown films are tubular in shape, controlling the thickness profile of the tubular blown film or of its constituent layers (as well as the profiles of other physical properties of the tubular blown film) is often done using measurements made on the bubble using backscatter sensors such as NDC Gamma, Capacitance and optical sensors.

Measurement on the bubble is restricted to backscatter sensors which are inherently less accurate than transmission sensors, and cannot make reliable constituent layer measurements.

It would be preferable to use transmission sensors which are more accurate than backscatter sensors and can in some versions also offer excellent constituent layer measurements as well as total measurements. However, transmission sensors cannot be fitted on the bubble as one sensor head would have to remain inside the bubble and this is impossible to achieve in practice.

In most blown film lines, the tubular blown film is folded (or collapsed after blowing and measurements at this position on this collapsed film are possible using both backscatter and transmission technology. However, as two layers of film are always present at this location, the problem of determining the measurement of the individual top and bottom layers must be solved.

Solution of this layer measurement problem would also give the possibility of a faster, more accurate measurement and control and the ability to make accurate multilayer measurements and controls.

Several prior art methods for controlling the thickness profile of the tubular blown film have attempted to control the thickness profile of the tubular blown film by using measurements made on the folded (double layer) film. The problem of measuring the folded blown film is that what is measured is the combined (double layer) thickness of two different sectors of the blown film. To effectively control the thickness profile of the blown film, it is necessary to determine the thickness of all (single layer) sectors around the circumference of the tubular blown film.

One prior art method of accomplishing this is to measure the combined thickness of the folded film only at the edges of the fold where the combined thickness of oppositely disposed sectors of the film can be assumed to be from the same sector. This method, however, requires fully rotating the blown film so that repeated measurements can be taken of each sector as each sector is rotated to the edges of the fold. This is time consuming, and can take 2 to 10 minutes, depending upon the speed of rotation of the blown film.

Another method of controlling the thickness profile of a tubular blown film is disclosed in European Patent EP 1 207 368 B1. In the method disclosed in this patent, the thickness of individual sectors of the blown film is estimated by a technique using the least squares method or weighted least squares method for solving hyper-constrained systems. The method described in this patent is also time consuming and requires about 10-20 scans of the folded film before thickness estimates of each sector can be calculated. Moreover, the resulting profile determination is merely an estimate of the true profile.

Accordingly, there is a need for a method for controlling the thickness profile of a tubular blown film which avoids the aforementioned problems in the prior art.

### SUMMARY OF THE INVENTION

The invention satisfies this need. The invention is a method for controlling a physical property, such as the thickness profile, of a collapsed tubular blown film extruded from a ring-shaped extruder having a plurality of physical property controllers disposed sequentially around the ring-shaped extruder. The method comprises the steps of (a) identifying an even number of n longitudinal sections of the blown film Sᵢ such that (i) S₁ and S_{i/2+1} edge sections are each folded in half over on themselves to form a first homogeneous two layer pairing and a second homogeneous two layer pairing and (ii) each of the other longitudinal sections Sᵢ are made contiguous with an opposed longitudinal section Sₙ₊₂₋ᵢ, so as to form a first set of n/2−2 contiguous heterogeneous two layer pairings; (b) measuring the physical property of the first homogeneous two layer pairing, the physical property of the second homogeneous two layer pairing and each of the first set of contiguous heterogeneous two layer pairings; (c) determining the physical property of the longitudinal section in the first homogenous two layer pairing by dividing by two the physical property measurement of the first homogeneous two layer pairing obtained in step (b); (d) determining the physical property of the longitudinal section in the second homogenous two layer pairing by dividing by two the physical property measurement of the second homogeneous two layer pairing obtained in step (b); (e) rotating the tubular film such that (i) two longitudinal sections, which are not S₁ and S_{i/2+1}, are folded over on themselves to form a third homogeneous two layer pairing and a fourth homogeneous two layer pairing, respectively, and (ii) each of the other longitudinal sections S₁ are made continuous with an opposed longitudinal section S_{n÷2-I}, so as to form a second set of n/2−2 contiguous heterogeneous two layer pairings; (f) measuring the physical property of the third homogenous two layer pairing the physical property of the fourth homogenous two layer pairing and each of the second set of contiguous heterogenous two layer pairings; (g) determining the physical property of the longitudinal section in the third homogenous two layer pairing by dividing by two the physical property measurement of the third homogenous two layer pairing obtained in step (f); (h) determining the physical property of the longitudinal section in the fourth homogenous two layer pairing by dividing by two the physical property measurement of the fourth homogenous two layer pairing obtain in step (f); (i) determining the physical property of the remaining longitudinal sections not determined in steps (c) (d) (g) and (h) by subtracting from physical property measurements of the first and second contiguous heterogenous two layer pairings obtained in steps (b) and (f) the physical properties of previously determined longitudinal sections; and (j) adjusting the physical property of at least one longitudinal section by identifying at least one physical property controller proximate to the at least one longitudinal section and by adjusting the at least one physical property controller.

In one aspect of the invention, the physical property is the total thickness of the blown film, or the thickness of its constituent layers. In other aspects of the invention, the physical property is the total weight per unit area of the blown film or of its constituent layers, or the density of the film, or of its constituent layers or the moisture content of the blown film.

### DRAWINGS

These and other features, aspects and advantages of the present invention will become better understood with reference to the following description, appended claims and accompanying drawings where:

FIG. 1 is a diagrammatic representation of a tubular blown film forming operation to which the invention can be applied;

FIG. 2 is a detailed diagrammatic representation of one aspect of the manufacturing method illustrated in FIG. 1, illustrating the physical property measurement of a flattened tubular blown film; and

FIG. 3 A is a diagrammatic representation of a collapsed blown film to which the method of the invention can be applied; and

FIG. 3B is a diagrammatic representation of the collapsed blown film illustrated in FIG. 3B, showing the blown film after it has been rotated.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

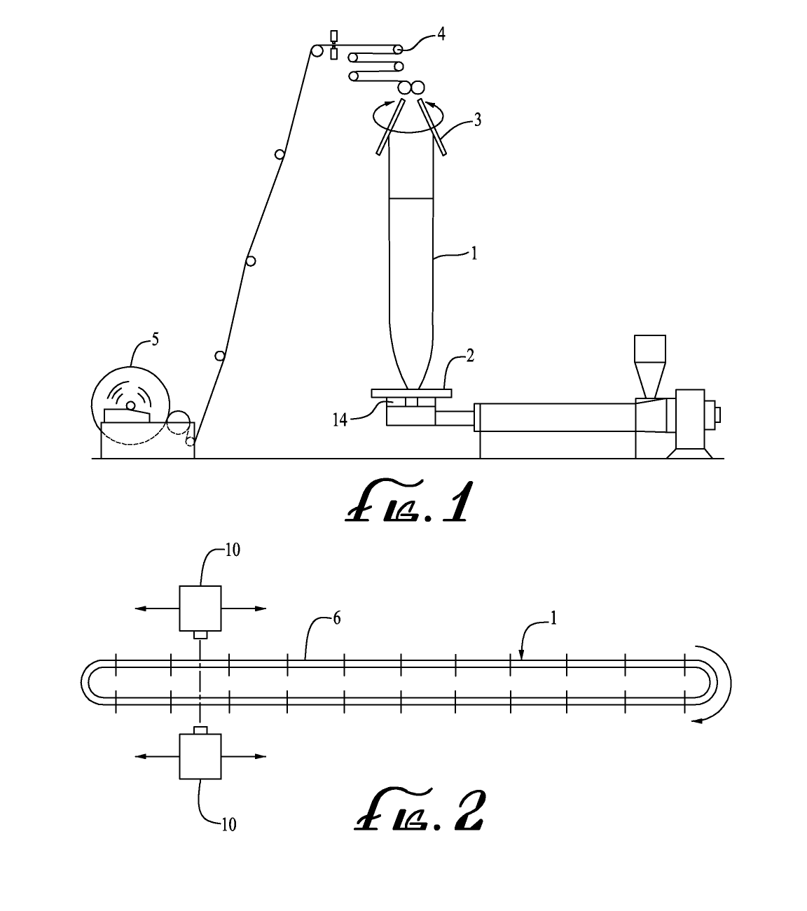

The invention is a method for controlling a physical property profile of a collapsed tubular blown film extruded from a ring-shaped extruder. FIG. 1 illustrates a typical tubular blown film 1 extruded from a ring-shaped extruder die 2. The ring-shaped extruder die has a plurality of physical property controllers 14 disposed around the ring-shaped extruder die.

As can be seen in FIG. 1, the blown film 1 is initially extruded as a cylindrical tube having a longitudinal axis. The cylindrically-shaped blown tube is folded by collapsing devices 3 such that the collapsed blown film 1 is converted from its initial cylindrically-shaped form to a flat, two-layer form. In the embodiment illustrated in FIG. 1, the blown film 1 in its flat, two-layer form is transferred via a series of rollers 4 to a take-up reel 5.

In one aspect of the invention, the physical property is the total thickness of the blown film, or the thickness of its constituent layers 1. In other aspects of the invention, the physical property is the weight per unit area of the blown film, or weight per unit area of its constituent layers 1, the density of the blown film, or density of its constituent layers 1 or the moisture content of the blown film 1.

The method of the invention comprises the steps of:

Step (a): Identifying an even number of n longitudinal sections 6 of the blown film Sᵢ such that (i) S₁ and S_{i/2+1} edge sections are each folded in half over on themselves to form a first homogeneous two layer pairing 7 and a second homogeneous two layer pairing 8 and (ii) each of the other longitudinal sections Sᵢ are made contiguous with an opposed longitudinal section Sₙ₊₂₋ᵢ, so as to form a first set of n/2−2 contiguous heterogeneous two layer pairings 9.

The location of each of the longitudinal sections 6 is typically monitored and retained by a computer. The number of the longitudinal sections 6 is typically between about 30 and about 3000, dependant, in part, on sensor resolution. The position has a simple relation to the control actuator positions, and the number of measured sections would typically be many more than the number of control elements. The measurement algorithm gives the fastest result when the number of measured segments is high, as only a small rotation is required before the layer measurements can be made.

Step (b): Measuring a physical property of the first homogeneous two layer pairing 7, the physical property of the second homogeneous two layer pairing 8 and each of the first set of contiguous heterogeneous two layer pairings 9.

The measurement is conducted edge to edge over the complete width of the folded film 1, and the measured values are stored in relation to their position across the folded film 1.

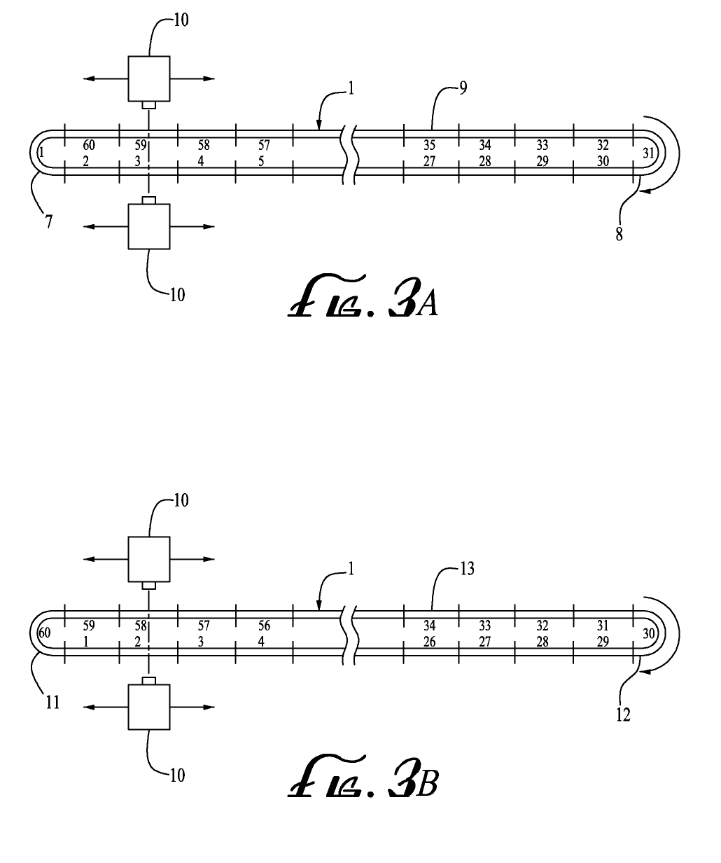

FIG. 2 illustrates a collapsed blown film 1 wherein a plurality of longitudinal sections 6 have been identified, and wherein a designated physical property, such as thickness, is measured by a sensor 10.

Where the physical property is thickness, it is typical that the measurements are made using backscatter-type or transmission-type sensors 10. Preferably, the sensors 10 are capable of measuring acquisition rates in the 50 Hz to 1 KHz range or faster, and most preferably in the range of between about 16 KHz to about 20 KHz acquisition rates and with a measurement beam resolution that allows identification of narrow longitudinal features in the 1-10 mm range or better. Use of such high speed high resolution sensors 10 allow the measurement to be used to control actuators at control rates which typically are between about 1 seconds and about 160 seconds. Preferably, the sensors 10 are of the type which do not require contact with the blown film 1.

Where the physical property is a physical property of one or more of constituent layers of a multi-layered blown film 1, sensors 10 capable of measuring the physical property of interest are employed. For example, infrared gauges which measure IR absorption spectra are capable of measuring thickness or weight-per-unit area of several different polymers simultaneously, such as nylon and polyethylene and various barrier or tie polymer layers.

Step (c): Determining the physical property of the longitudinal section 6 in the first homogenous two layer pairing 7 by dividing by two the physical property measurement of the first homogeneous two layer pairing 7 obtained in step (b).

Since the two edge longitudinal sections 6 are folded over themselves, measuring these sections 6 allows their values to be determined by simply dividing each measured value in two.

Step (d): Determining the physical property of the longitudinal section 6 in the second homogenous two layer pairing 8 by dividing by two the physical property measurement of the second homogeneous two layer pairing 8 obtained in step (b).

It is readily appreciated that by dividing the physical property of each longitudinal section 6 in the first and second homogenous two-layer pairings 7 and 8 by two's, the average physical property of each layer within the first and second homogenous two-layer pairings 7 and 8 are determined.

Step (e): Rotating the tubular film 1 such that (i) two longitudinal sections 6, which are not S and S_{i/2+1}, are folded over on themselves to form a third homogeneous two layer pairing 11 and a fourth homogeneous two layer pairing 12, respectively, and (ii) each of the other longitudinal sections S₁ are made continuous with an opposed longitudinal section S_{n+2-I}, so as to form a second set of n/2−2 contiguous heterogeneous two layer pairings 13.

Thus, the film 1 is rotated such that the two new edge sections 6 adjacent to the previously measured edge sections 6 now occupy the edge areas, and the previously calculated edge areas now overlap two unknown areas.

The blown film 1 is usually rotated by the extruder die or by the take-up reel 5. Typically, the blown film 1 rotates back and forth, initially 360° in the first direction, then reversing and rotating 360° in the opposite direction, and continuing on this back and forth rotational sequence. (Other angular rotations are also possible.) It is typical for the blown film 1 to completely rotate in between about 2 minutes and about 10 minutes.

The velocity with which a tubular film 1 is rotated can be precisely measured and the physical location around the perimeter of the blown film 1 of each of the longitudinal sections 6 can be precisely determined by methods known to those of ordinary skill in the technology.

Step (f): Measuring the physical property of the third homogenous two layer pairing 11 the physical property of the fourth homogenous two layer pairing 12 and each of the second set of contiguous heterogenous two layer pairings 13.

In the physical property measuring steps (b) and (f), at least one physical property measurement is made across each homogeneous two-layer pairing and across each contiguous heterogeneous two-layer pairing. Most typically, however, multiple physical property measurements are made across each homogenous two-layer pairing and across each heterogeneous two-layer pairing.

Step (g): Determining the physical property of the longitudinal section 6 in the third homogenous two layer pairing 11 by dividing by two the physical property measurement of the third homogenous two layer pairing 11 obtained in step (f).

Step (h): Determining the physical property of the longitudinal section 6 in the fourth homogenous two layer pairing 12 by dividing by two the physical property measurement of the fourth homogenous two layer pairing 12 obtained in step (f).

Step (i): Determining the physical property of the remaining longitudinal sections 6 not determined in steps (c) (d) (g) and (h) by subtracting from physical property measurements of the first and second contiguous heterogenous two layer pairings 7, 8, 11 and 12 obtained in steps (b) and (f) the physical properties of previously determined longitudinal sections 6.

After step (h), two values are known at each edge, the current edge value and the last edge value. As the last edge value now overlaps a new unknown value, this new unknown can be calculated by subtracting the known last edge value from the current two layer measurement. Similarly, as the previous scan was also stored, the current known edge value can be subtracted from the prior scan value where the current edge overlapped a different unknown area, thus giving four new known values, which in turn can be used to calculate other unknowns. This step of subtracting known values from overlapping unknown values on both the current and the last profile can be used to process the whole profile in a fast combinatorial sequence that calculates all of the layer measurements.

Step (j): Adjusting the physical property of at least one longitudinal section 6 by identifying at least one film physical property controller 14 proximate to the at least one longitudinal section 6 and by adjusting the at least one film physical property controller 14.

Where the physical property is thickness, the physical property controllers 14 are typically film thickness controllers 14 comprising die or air-ring control actuators. Other alternative actuators 14 are also commonly known to the trade.

Note that the above-described steps of the invention are not necessarily carried out in the order listed.

The physical property measurements and all physical property determinations are stored, typically in a computer database. A computer is also typically used to make all of the computations required in the method.

The results are thus calculated from just two scans and are exact, assuming little or no change between the two scans except for the rotation.

It can also be seen that the higher the resolution of the measurement zones the sheet 1 is divided into, the faster the calculation can be completed as less rotation is required before the calculation can proceed, so this benefits the use of fast, lower noise, high positional resolution sensors 10.

It is also preferred in the industry to have a higher measurement position resolution than the control actuator resolution, since once the exact measurement profile is known at high resolution, it is a simple matter to re-partition it into actuator zones.

FIGS. 3A and 3B illustrate one example of the method of the invention. In this example, the physical property of the blown film is its thickness.

Regarding this example, in step (a) of the method, sixty longitudinal sections of the blown film are identified as shown in FIG. 3A, thirty on the first side of the folded, two-layer tubular (identified by numbers 1-30) film and thirty are identified on the second layer of the folded, two-layer tubular blown film (identified by the numbers 31-60).

Continuing in the example, the first longitudinal section (S₁) is disposed folded over a first end of the folded, two-layered tubular blown film and the 31st longitudinal section is folded over the opposite end of the folded, two-layer tubular blown film. Each of the other longitudinal sections (Sᵢ) are made contiguous with opposed longitudinal sections (S₁ₙ₊₂₋ᵢ) so as to form a first set of n/2−2 contiguous homogenous two-layer pairing. For instance, the second longitudinal section is made contiguous with the sixtieth longitudinal section, the third longitudinal section is made contiguous with the fifty-ninth longitudinal section, the fourth longitudinal section is made contiguous with the fifty-eighth longitudinal section, and so on.

The thickness is then measured in step (b) of the method across the entire width of the collapsed film. Since the first longitudinal section of the folded, two-layer tubular blown film and the thirty-first longitudinal section are folded over on themselves, the measured thickness value is approximately double the true thickness value at each of those longitudinal sections.

Assume, for illustration's sake, that the 60 longitudinal sections have the thickness values set forth in TABLE 1.

TABLE 1

| | | First Measurement | | Second Measurement | |
|---|---|---|---|---|---|
| Longitudinal | Actual Thickness | Longitudinal | Combined Thickness | Longitudinal Section | Combined Thickness |
| Section # | (Microns) | Section Paired With | of Pair (Microns) | Paired With | of Pair (Microns) |
| 1 | 76 | 1 | 152 | 59 | 159 |
| 2 | 80 | 60 | 164 | 58 | 163 |
| 3 | 68 | 59 | 151 | 57 | 148 |
| 4 | 71 | 58 | 154 | 56 | 150 |
| 5 | 73 | 57 | 153 | 55 | 153 |
| 6 | 68 | 56 | 147 | 54 | 147 |
| 7 | 75 | 55 | 155 | 53 | 151 |
| 8 | 81 | 54 | 160 | 52 | 159 |
| 9 | 79 | 53 | 155 | 51 | 153 |
| 10 | 70 | 52 | 148 | 50 | 144 |
| 11 | 67 | 51 | 141 | 49 | 140 |
| 12 | 69 | 50 | 143 | 48 | 138 |
| 13 | 70 | 49 | 143 | 47 | 138 |
| 14 | 72 | 48 | 141 | 46 | 137 |
| 15 | 74 | 47 | 142 | 45 | 141 |
| 16 | 78 | 46 | 143 | 44 | 146 |
| 17 | 82 | 45 | 149 | 43 | 154 |
| 18 | 86 | 44 | 154 | 42 | 156 |
| 19 | 84 | 43 | 156 | 41 | 158 |
| 20 | 86 | 42 | 156 | 40 | 161 |
| 21 | 84 | 41 | 158 | 39 | 161 |
| 22 | 81 | 40 | 156 | 38 | 164 |
| 23 | 74 | 39 | 151 | 37 | 153 |
| 24 | 78 | 38 | 161 | 36 | 158 |
| 25 | 73 | 37 | 152 | 35 | 151 |
| 26 | 70 | 36 | 150 | 34 | 146 |
| 27 | 71 | 35 | 149 | 33 | 139 |
| 28 | 70 | 34 | 146 | 32 | 137 |
| 29 | 69 | 33 | 137 | 31 | 136 |
| 30 | 64 | 32 | 131 | 30 | 128 |
| 31 | 67 | 31 | 134 | 29 | 136 |
| 32 | 67 | 30 | 131 | 28 | 137 |
| 33 | 68 | 29 | 137 | 27 | 139 |
| 34 | 76 | 28 | 146 | 26 | 146 |
| 35 | 78 | 27 | 149 | 25 | 151 |
| 36 | 80 | 26 | 150 | 24 | 158 |
| 37 | 79 | 25 | 152 | 23 | 153 |
| 38 | 83 | 24 | 161 | 22 | 164 |
| 39 | 77 | 23 | 151 | 21 | 161 |
| 40 | 75 | 22 | 156 | 20 | 161 |
| 41 | 74 | 21 | 158 | 19 | 158 |
| 42 | 70 | 20 | 156 | 18 | 156 |
| 43 | 72 | 19 | 156 | 17 | 154 |
| 44 | 68 | 18 | 154 | 16 | 146 |
| 45 | 67 | 17 | 149 | 15 | 141 |
| 46 | 65 | 16 | 143 | 14 | 137 |
| 47 | 68 | 15 | 142 | 13 | 138 |
| 48 | 69 | 14 | 141 | 12 | 138 |
| 49 | 73 | 13 | 143 | 11 | 140 |
| 50 | 74 | 12 | 143 | 10 | 144 |
| 51 | 74 | 11 | 141 | 9 | 153 |
| 52 | 78 | 10 | 148 | 8 | 159 |
| 53 | 76 | 9 | 155 | 7 | 151 |
| 54 | 79 | 8 | 160 | 6 | 147 |
| 55 | 80 | 7 | 155 | 5 | 153 |
| 56 | 79 | 6 | 147 | 4 | 150 |
| 57 | 80 | 5 | 153 | 3 | 148 |
| 58 | 83 | 4 | 154 | 2 | 163 |
| 59 | 83 | 3 | 151 | 1 | 159 |
| 60 | 84 | 2 | 164 | 60 | 168 |

In the first profile measurement scan, the combined thicknesses of the doubled over end sections 1 and 31 are 152 microns and 134 microns, respectively. Thus, the thickness of these doubled over end portions can be easily determined in steps (c) and (d) of the method by dividing the initial measurements by two (i.e., 152÷2=76 and 134÷2=67).

The measured values of each of the contiguous heterogeneous two-layer pairings comprise the summation of the thicknesses of each longitudinal section in that contiguous heterogenous two-layer pairing. Assuming the thickness values in TABLE 1, it can be seen that the measured physical property value comprising the second longitudinal section and the sixtieth longitudinal section (164 microns) is the sum of the true thickness value of the second longitudinal section (80 microns) and the true thickness value of the sixtieth section (84 microns), the measured thickness value of the contiguous two-layer pairing comprising the third longitudinal section and the fifty-ninth longitudinal section (151 microns) is the sum of the true thickness value of the third longitudinal section (68 microns) and the true thickness value of the fifty-ninth longitudinal section (83 microns), the measured thickness value of the contiguous heterogenous two-layer pairing comprising the fourth longitudinal section and the fifty-eighth longitudinal section (154 microns) is the sum of the true thickness values of the fourth longitudinal section (71 microns) and the fifty-eighth longitudinal section (83 microns), and so on.

Next in this example, the collapsed film is rotated in step (e) of the method such that the first longitudinal section and the thirty-first longitudinal section are no longer at the edge on opposite ends of the collapsed two-layer tubular blown film. In this example, as illustrated in FIG. 3B, the thirtieth longitudinal section and the sixtieth longitudinal section are folded over on themselves at the edge, therefore forming a second pair of contiguous homogenous two-layer pairing. The remaining longitudinal sections are again disposed contiguous with other longitudinal sections to form a second set of fifty-eight contiguous heterogenous sections.

Still further in this example, the thickness profile is (again) measured in step (f) of the method across the entire width of the collapsed film. In this second physical property profile measurement, again assuming the thickness values in TABLE 1, it can be seen that the thirtieth longitudinal section and the sixtieth longitudinal section are now folded over on themselves, so that the measured thickness values at the two opposite ends of the two-layer, tubular blown film (single layer being 64 microns and 84 microns, respectively) is double the true thickness values of each of these longitudinal sections in the folded measurement (128 and 168 microns respectively).

The measured values of each of the contiguous heterogenous two-layer pairings again comprise the summation of the thickness values of each longitudinal section in that contiguous heterogenous two-layer pairing. Yet again, assuming the thickness values in TABLE 1, it can be seen that, in the second physical property profile measurement, the measured thickness property value comprising the first longitudinal section and the fifty-ninth longitudinal section (159 microns) is the sum of the true thickness value of the first longitudinal section (76 microns) and the true physical property value of the fifty-ninth longitudinal section (83 microns), the measured thickness value of the contiguous two-layer pairing comprising the second longitudinal section and the fifty-eighth longitudinal section (163 microns) is the sum of the true thickness value of the second longitudinal section (80 microns) and the true thickness value of the fifty-eighth longitudinal section (83 microns), the measured thickness value of the contiguous heterogenous two-layer pairing comprising the third longitudinal section and the fifty-seventh longitudinal section (148 microns) is the sum of the true thickness values of the third longitudinal section (68 microns) and the fifty-seventh longitudinal section (80 microns), and so on.

Continuing in this example, the true thickness value of the sixtieth longitudinal section (84 microns) is determined in step (g) by dividing the thickness value (168 microns) by two (168÷2=84) and the true thickness value of the thirtieth longitudinal section (64 microns) is determined in step (h) by dividing the measurement of the folded over thirtieth longitudinal section (128 microns) in the second physical thickness measurement by two (128÷2=64).

Thus in this example, it can be seen that the true thickness values of the first longitudinal section, the thirtieth longitudinal section, the thirty-first longitudinal section and the sixtieth longitudinal section can be easily determined after two scans separated by a rotation.

The true value of the thickness of each of the remaining longitudinal sections are determined by subtracting the true value of a previously determined thickness of a longitudinal section from the thickness measurement, in either the first thickness measurement or the second thickness measurement. This can be seen most easily by reference to TABLES 2-5.

TABLE 2

| | | | Combined | | | |
|---|---|---|---|---|---|---|
| | | | Thickness − | | | |
| | | | Known | | | |
| Previously | Previously | | Thickness = | | | Newly |
| Determined | Undetermined | Measure- | Newly | | | Determined |
| Longitudinal | Longitudinal | ment | Determined | | | Longitudinal |
| Section | Section | No. | Thickness | | | Section |
| 1 | 59 | 2 | 159 | 76 | 83 | 59 |
| 59 | 3 | 1 | 151 | 83 | 68 | 3 |
| 3 | 57 | 2 | 148 | 68 | 80 | 57 |
| 57 | 5 | 1 | 153 | 80 | 73 | 5 |
| 5 | 55 | 2 | 153 | 73 | 80 | 55 |
| 55 | 7 | 1 | 155 | 80 | 75 | 7 |
| 7 | 53 | 2 | 151 | 75 | 76 | 53 |
| 53 | 9 | 1 | 155 | 76 | 79 | 9 |
| 9 | 51 | 2 | 153 | 79 | 74 | 51 |
| 51 | 11 | 1 | 141 | 74 | 67 | 11 |
| 11 | 49 | 2 | 140 | 67 | 73 | 49 |
| 49 | 13 | 1 | 143 | 73 | 70 | 13 |
| 13 | 47 | 2 | 138 | 70 | 68 | 47 |
| 47 | 15 | 1 | 142 | 68 | 74 | 15 |
| 15 | 45 | 2 | 141 | 74 | 67 | 45 |
| 45 | 17 | 1 | 149 | 67 | 82 | 17 |
| 17 | 43 | 2 | 154 | 82 | 72 | 43 |
| 43 | 19 | 1 | 156 | 72 | 84 | 19 |
| 19 | 41 | 2 | 158 | 84 | 74 | 41 |
| 41 | 21 | 1 | 158 | 74 | 84 | 21 |
| 21 | 39 | 2 | 161 | 84 | 77 | 39 |
| 39 | 23 | 1 | 151 | 77 | 74 | 23 |
| 23 | 37 | 2 | 153 | 74 | 79 | 37 |
| 37 | 25 | 1 | 152 | 79 | 73 | 25 |
| 25 | 35 | 2 | 151 | 73 | 78 | 35 |
| 35 | 27 | 1 | 149 | 78 | 71 | 27 |
| 27 | 33 | 2 | 139 | 71 | 68 | 33 |
| 33 | 29 | 1 | 137 | 68 | 69 | 29 |
| 29 | 31 | 2 | 136 | 69 | 67 | 31 |

TABLE 3

| | | | Combined | | | |
|---|---|---|---|---|---|---|
| | | | Thickness − | | | |
| | | | Known | | | |
| Previously | Previously | | Thickness = | | | Newly |
| Determined | Undetermined | Measure- | Newly | | | Determined |
| Longitudinal | Longitudinal | ment | Determined | | | Longitudinal |
| Section | Section | No. | Thickness | | | Section |
| 31 | 29 | 2 | 136 | 67 | 69 | 29 |
| 29 | 33 | 1 | 137 | 69 | 68 | 33 |
| 33 | 27 | 2 | 139 | 68 | 71 | 27 |
| 27 | 35 | 1 | 149 | 71 | 78 | 35 |
| 35 | 25 | 2 | 151 | 78 | 73 | 25 |
| 25 | 37 | 1 | 152 | 73 | 79 | 37 |
| 37 | 23 | 2 | 153 | 79 | 74 | 23 |
| 23 | 39 | 1 | 151 | 74 | 77 | 39 |
| 39 | 21 | 2 | 161 | 77 | 84 | 21 |
| 21 | 41 | 1 | 158 | 84 | 74 | 41 |
| 41 | 19 | 2 | 158 | 74 | 84 | 19 |
| 19 | 43 | 1 | 156 | 84 | 72 | 43 |
| 43 | 17 | 2 | 154 | 72 | 82 | 17 |
| 17 | 45 | 1 | 149 | 82 | 67 | 45 |
| 45 | 15 | 2 | 141 | 67 | 74 | 15 |
| 15 | 47 | 1 | 142 | 74 | 68 | 47 |
| 47 | 13 | 2 | 138 | 68 | 70 | 13 |
| 13 | 49 | 1 | 143 | 70 | 73 | 49 |
| 49 | 11 | 2 | 140 | 73 | 67 | 11 |
| 11 | 51 | 1 | 141 | 67 | 74 | 51 |
| 51 | 9 | 2 | 153 | 74 | 79 | 9 |
| 9 | 53 | 1 | 155 | 79 | 76 | 53 |
| 53 | 7 | 2 | 151 | 76 | 75 | 7 |
| 7 | 55 | 1 | 155 | 75 | 80 | 55 |
| 55 | 5 | 2 | 153 | 80 | 73 | 5 |
| 5 | 57 | 1 | 153 | 73 | 80 | 57 |
| 57 | 3 | 2 | 148 | 80 | 68 | 3 |
| 3 | 59 | 1 | 151 | 68 | 83 | 59 |
| 59 | 1 | 2 | 159 | 83 | 76 | 1 |

TABLE 4

| | | | Combined | | | |
|---|---|---|---|---|---|---|
| | | | Thickness − | | | |
| | | | Known | | | |
| Previously | Previously | | Thickness = | | | Newly |
| Determined | Undetermined | Measure- | Newly | | | Determined |
| Longitudinal | Longitudinal | ment | Determined | | | Longitudinal |
| Section | Section | No. | Thickness | | | Section |
| 30 | 32 | 1 | 131 | 64 | 67 | 32 |
| 32 | 28 | 2 | 137 | 67 | 70 | 28 |
| 28 | 34 | 1 | 146 | 70 | 76 | 34 |
| 34 | 26 | 2 | 146 | 76 | 70 | 26 |
| 26 | 36 | 1 | 150 | 70 | 80 | 36 |
| 36 | 24 | 2 | 158 | 80 | 78 | 24 |
| 24 | 38 | 1 | 161 | 78 | 83 | 38 |
| 38 | 22 | 2 | 164 | 83 | 81 | 22 |
| 22 | 40 | 1 | 156 | 81 | 75 | 40 |
| 40 | 20 | 2 | 161 | 75 | 86 | 20 |
| 20 | 42 | 1 | 156 | 86 | 70 | 42 |
| 42 | 18 | 2 | 156 | 70 | 86 | 18 |
| 18 | 44 | 1 | 154 | 86 | 68 | 44 |
| 44 | 16 | 2 | 146 | 68 | 78 | 16 |
| 16 | 46 | 1 | 143 | 78 | 65 | 46 |
| 46 | 14 | 2 | 137 | 65 | 72 | 14 |
| 14 | 48 | 1 | 141 | 72 | 69 | 48 |
| 48 | 12 | 2 | 138 | 69 | 69 | 12 |
| 12 | 50 | 1 | 143 | 69 | 74 | 50 |
| 50 | 10 | 2 | 144 | 74 | 70 | 10 |
| 10 | 52 | 1 | 148 | 70 | 78 | 52 |
| 52 | 8 | 2 | 159 | 78 | 81 | 8 |
| 8 | 54 | 1 | 160 | 81 | 79 | 54 |
| 54 | 6 | 2 | 144 | 79 | 68 | 6 |
| 6 | 56 | 1 | 147 | 68 | 79 | 56 |
| 56 | 4 | 2 | 150 | 79 | 71 | 4 |
| 4 | 58 | 1 | 154 | 71 | 83 | 58 |
| 58 | 2 | 2 | 163 | 83 | 80 | 2 |
| 2 | 60 | 1 | 164 | 80 | 84 | 60 |

TABLE 5

| | | | Combined | | | |
|---|---|---|---|---|---|---|
| | | | Thickness − | | | |
| | | | Known | | | |
| Previously | Previously | | Thickness = | | | Newly |
| Determined | Undetermined | Measure- | Newly | | | Determined |
| Longitudinal | Longitudinal | ment | Determined | | | Longitudinal |
| Section | Section | No. | Thickness | | | Section |
| 60 | 2 | 1 | 168 | 84 | 80 | 2 |
| 2 | 58 | 2 | 163 | 80 | 83 | 58 |
| 58 | 4 | 1 | 154 | 83 | 71 | 4 |
| 4 | 56 | 2 | 150 | 71 | 79 | 56 |
| 56 | 6 | 1 | 147 | 79 | 68 | 6 |
| 6 | 54 | 2 | 147 | 68 | 79 | 54 |
| 54 | 8 | 1 | 154 | 79 | 81 | 8 |
| 8 | 52 | 2 | 159 | 81 | 78 | 52 |
| 52 | 10 | 1 | 148 | 78 | 70 | 10 |
| 10 | 50 | 2 | 144 | 70 | 74 | 50 |
| 50 | 12 | 1 | 143 | 74 | 69 | 12 |
| 12 | 48 | 2 | 138 | 69 | 69 | 48 |
| 48 | 14 | 1 | 144 | 69 | 72 | 14 |
| 14 | 46 | 2 | 137 | 72 | 65 | 46 |
| 46 | 16 | 1 | 143 | 65 | 78 | 16 |
| 16 | 44 | 2 | 146 | 78 | 68 | 44 |
| 44 | 18 | 1 | 154 | 68 | 86 | 18 |
| 18 | 42 | 2 | 156 | 86 | 70 | 42 |
| 42 | 20 | 1 | 156 | 70 | 86 | 20 |
| 20 | 40 | 2 | 161 | 86 | 75 | 40 |
| 40 | 22 | 1 | 156 | 75 | 81 | 22 |
| 22 | 38 | 2 | 164 | 81 | 83 | 38 |
| 38 | 24 | 1 | 161 | 83 | 78 | 24 |
| 24 | 36 | 2 | 158 | 78 | 80 | 36 |
| 36 | 26 | 1 | 150 | 80 | 70 | 26 |
| 26 | 34 | 2 | 146 | 70 | 76 | 34 |
| 34 | 28 | 1 | 146 | 76 | 70 | 28 |
| 28 | 32 | 2 | 137 | 70 | 67 | 32 |
| 32 | 30 | 1 | 131 | 67 | 64 | 30 |

In TABLE 2, it can be seen that the true thickness value of the fifty-ninth longitudinal section (83 microns) is determined by subtracting the known value of the true thickness of the fifty-ninth longitudinal section and the first longitudinal section in the second measurement step (159 microns): 159−76=83 microns. Continuing with reference to TABLE 2, after the true thickness value of the fifty-ninth longitudinal section is determined, the truth thickness value of the third longitudinal section can be determined by subtracting the known value of the true thickness of the fifty-ninth longitudinal section and the third longitudinal section in the first measurement step (151 microns): 151−83=68 microns. Once the true thickness value of the third longitudinal section is determined, as can be seen in TABLE 2, the true thickness value of the fifty-seventh longitudinal section can be determined by subtracting the known value of the true thickness of the third longitudinal section from the thickness of the heterogenous pair comprising the fifty-seventh longitudinal section and the third longitudinal section (148 microns) which was measured in the second measurement step (148−68=80 microns). As can be further seen in TABLE 2, by repeating these determination steps, the true thickness values of all of the odd numbered longitudinal sections can be determined.

In similar fashion, as can be seen in TABLE 3, all of the true thickness values of the odd numbered longitudinal sections can alternatively be determined by starting with the previously determined true thickness value of the thirty-first longitudinal section. The true thickness value of the twenty-ninth longitudinal section (69 microns) is determined by subtracting the known value of the true thickness of the thirty-first longitudinal section (67 microns) from the thickness measurement of the twenty-ninth longitudinal section and the thirty-first longitudinal section in the second measurement step (136 microns): 136−67=69 microns. Once the true thickness value of the twenty-ninth longitudinal section is determined, as can be seen in TABLE 3, the true thickness value of the thirty-third longitudinal section can be determined by subtracting the known value of the true thickness of the twenty-ninth longitudinal section from the thicknesses of the heterogenous pair comprising the twenty-ninth longitudinal section and the thirty-third longitudinal section (137 microns) which was measured in the first measurement step (37−69=68 microns). As can be further seen in TABLE 3, by repeating these determination steps, the true thickness values of all of the odd numbered longitudinal sections can be determined.

TABLE 4 illustrates how all of the true thickness values of each of the even numbered longitudinal sections can be determined starting with the previously determined true thickness value of the thirtieth longitudinal section. The true thickness value of the thirty-second longitudinal section (67 microns) is determined by subtracting the known value of the true thickness of the thirtieth longitudinal section (64 microns) from the thickness measurement of the thirty-second longitudinal section and the thirtieth longitudinal section in the first measurement step (131 microns): 131−64=67 microns. Once the true thickness value of the thirty-second longitudinal section is determined, as can be seen in TABLE 4, the true thickness value of the twenty-eighth longitudinal section can be determined by subtracting the known value of the true thickness of the thirty-second longitudinal section from the thickness of the heterogenous pair comprising the thirty-second longitudinal section and the twenty-eighth longitudinal section (137 microns) which was measured in the second measurement step (137−67=70 microns). As can be further seen in TABLE 4, by repeating these determination steps, the true thickness values of all of the even numbered longitudinal sections can be determined.

TABLE 5 illustrates how the true thickness values of the even numbered longitudinal sections can alternatively be determined by starting with the previously determined true thickness value of the sixtieth longitudinal section. The true thickness value of the second longitudinal section (80 microns) is determined by subtracting the known value of the true thickness of the sixtieth longitudinal section (84 microns) from the thickness measurement of the sixtieth and second longitudinal sections in the first measurement step (164 microns): 164−84=80 microns. Once the true thickness value of the second longitudinal section is determined, as can be seen in TABLE 5, the true thickness value of the fifty-eighth longitudinal section can be determined by subtracting the known value of the true thickness of the second longitudinal section from the thickness of the heterogenous pair comprising the second longitudinal section and the fifty-eighth longitudinal section (163 microns) which was measured in the second measurement step (163−80=83 microns). As can be further seen in TABLE 5, by repeating these determination steps, the true thickness values of all of the odd numbered longitudinal sections can be determined.

Finally in this example, once the thicknesses of all of the longitudinal sections have been determined, the thickness of one or more of the longitudinal sections can be adjusted in step (j) by adjusting one or more of the thickness controllers disposed around the ring-shaped extruder.

The method is almost exact, as it uses the exact known edge data, and then uses this to expand out to calculate further known areas from adjacent unknown areas in a fast combinational sequence. Each previously known area that is rotated over a previously unknown area is used by subtraction to derive the next unknown area resulting in a new known area. This sequence is then repeated until the whole profile is derived. The method can result in complete profile derivation in only two scans. The method yields accurate results, not mere approximations derived from by least squares methods or by other approximation methods.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A method for controlling a physical property of a collapsed tubular blown film extruded from a ring-shaped extruder having a plurality of film physical property controllers disposed sequentially around the ring-shaped extruder, the method comprising the following steps:
(a) identifying an even number of n longitudinal sections of the blown film Sᵢ such that (i) S₁ and S_{i/2+1} edge sections are each folded in half over on themselves to form a first homogeneous two layer pairing and a second homogeneous two layer pairing and (ii) each of the other longitudinal sections Sᵢ are made contiguous with an opposed longitudinal section Sₙ₊₂₋ᵢ, so as to form a first set of n/2−2 contiguous heterogeneous two layer pairings;
(b) measuring the physical property of the first homogeneous two layer pairing, the physical property of the second homogeneous two layer pairing and each of the first set of contiguous heterogeneous two layer pairings;
(c) determining the physical property of the longitudinal section in the first homogenous two layer pairing by dividing by two the physical property measurement of the first homogeneous two layer pairing obtained in step (b);
(d) determining the physical property of the longitudinal section in the second homogenous two layer pairing by dividing by two the physical property measurement of the second homogeneous two layer pairing obtained in step (b);
(e) rotating the tubular film such that (i) two longitudinal sections, which are not S₁ and S_{i/2+1}, are folded over on themselves to form a third homogeneous two layer pairing and a fourth homogeneous two layer pairing, respectively, and (ii) each of the other longitudinal sections S₁ are made continuous with an opposed longitudinal section S_{n+2-I}, so as to form a second set of n/2−2 contiguous heterogeneous two layer pairings;
(f) measuring the physical property of the third homogenous two layer pairing the physical property of the fourth homogenous two layer pairing and each of the second set of contiguous heterogenous two layer pairings;
(g) determining the physical property of the longitudinal section in the third homogenous two layer pairing by dividing by two the physical property measurement of the third homogenous two layer pairing obtained in step (f);
(h) determining the physical property of the longitudinal section in the fourth homogenous two layer pairing by dividing by two the physical property measurement of the fourth homogenous two layer pairing obtain in step (f);
(i) determining the physical property of the remaining longitudinal sections not determined in steps (c) (d) (g) and (h) by subtracting from physical property measurements of the first and second contiguous heterogenous two layer pairings obtained in steps (b) and (f) the physical properties of previously determined longitudinal sections; and
(j) adjusting the physical property of at least one longitudinal section by identifying at least one film physical property controller proximate to the at least one longitudinal section and by adjusting the at least one film physical property controller.

2. The method of claim 1 wherein the physical property is total thickness.

3. The method of claim 1 wherein the physical property is constituent layer thickness.

4. The method of claim 1 wherein the physical property is weight per unit area.

5. The method of claim 1 wherein the physical property is constituent layer weight per unit area.

6. The method of claim 1 wherein the physical property is density.

7. The method of claim 1 wherein the physical property is constituent layer density.

8. The method of claim 1 wherein the physical property is moisture content.
